(19) United States
(12) Patent Application Publication
(10) Pub. No.: US 2004/0233316 A1
(43) Pub. Date: Nov. 25, 2004

(54) Camera menu system

(76) Inventors: Amy E. Battles, Windsor, CO (US); Robb Cazier, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/442,839

(22) Filed: May 21, 2003

(51) Int. Cl. H04N 7/18

(52) U.S. Cl. 348/333.02

(57) ABSTRACT

A camera having expert and novice menus comprising a user interface associated with the camera and logic for providing a first menu via a display, the first menu having first information is disclosed. The camera also includes logic for providing a second menu via the display, the second menu nested within the first menu and having second information, wherein the second information includes details corresponding to the first information.

### BACKGROUND

The user interface in today's cameras, and particularly digital cameras, generally includes a number of buttons, switches, or control surfaces, and a display screen. The user interface is typically presented to the user through successive menus that are displayed to the user via the display.

Menus are included for functions such as controlling the settings used to capture and display an image. For many functions, current microprocessor controlled cameras provide either a high level menu showing current settings for a number of parameters, or a detailed sub-menu, providing much detail for each parameter. The high-level menu approach allows quick access to the parameters, while the sub-menu approach allows more detail to be communicated to the user about the parameter. Unfortunately, sophisticated users may be comfortable with the high-level menus, while novice users may prefer a more detailed sub-menu for a given parameter.

Furthermore, as more features and options become available on cameras, the user interface is likely to become increasingly complex, perhaps to the point where the novice user will be discouraged from using the camera.

Therefore, it would be desirable to provide a user interface on a camera that can be useful to both the sophisticated and casual user.

### SUMMARY

A system and method for expert and novice menus in a camera are described. One embodiment of the invention is a camera having expert and novice menus, comprising a user interface associated with the camera and logic for providing a first menu via a display, the first menu having first information. The camera also includes logic for providing a second menu via the display, the second menu nested within the first menu and having second information, wherein the second information includes details corresponding to the first information.

Related methods of operation and computer readable media are also described. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating a digital camera constructed in accordance with an embodiment of the invention.

FIG. 2 is a flow chart describing the operation of an embodiment of the expert and novice menu logic as shown in FIG. 1.

FIGS. 3A and 3B are graphical illustrations showing examples of expert and novice menus provided by the logic as shown in FIG. 1.

### DETAILED DESCRIPTION

The embodiment of the menu system described below is described with reference to a digital camera, but is applicable to any camera, e.g., a film camera, that provides menus as part of a user interface. The system and method for providing expert and novice menus can be implemented in hardware, software, firmware, or a combination thereof. Certain embodiments of the invention are implemented using a combination of hardware and software or firmware that is stored in a memory and that is executed by a suitable instruction execution system. The hardware portion can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. The software portion can be stored in one or more memory elements and executed by a suitable general purpose or application-specific processor.

The software for providing expert and novice menus, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

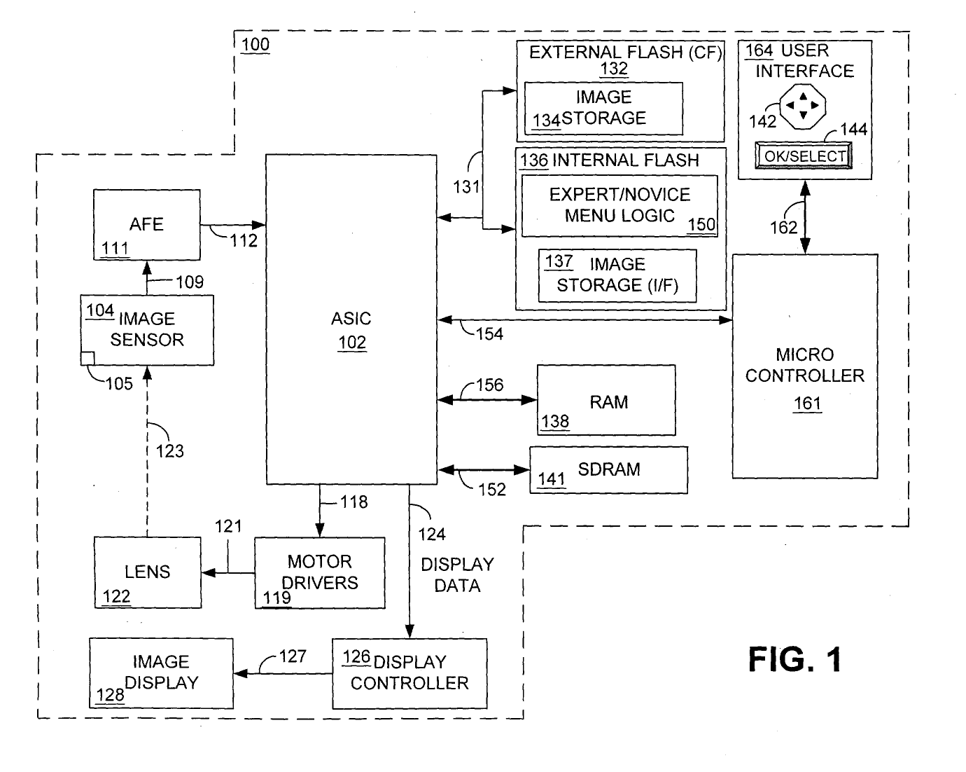

FIG. 1 is a block diagram illustrating a digital camera 100 constructed in accordance with an embodiment of the invention. In the implementation described below, the digital camera 100 includes an application specific integrated circuit (ASIC) 102 that executes expert and novice menu logic 150. As will be described below, the expert and novice menu logic 150 can be software that is stored in memory and executed by the ASIC 102. In an alternative embodiment, the expert and novice menu logic 150 may be implemented in firmware, which can be stored and executed in the ASIC 102. Further, while illustrated using a single ASIC 102, the digital camera 100 may include additional processors, digital signal processors (DSPs) and ASICs.

The ASIC 102 may also include other elements, which are omitted for simplicity. The ASIC 102 also controls the function of various aspects of the digital camera 100.

The camera 100 includes an image sensor 104. The image sensor 104 may comprise a charge coupled device (CCD) array or an array of complementary metal oxide semiconductor (CMOS) sensors. Regardless of whether the image sensor 104 comprises an array of individual CCD elements or CMOS sensors, each of the elements in the array comprises a pixel (picture element) of the image sensor 104. An exemplar image capture element, or pixel, is indicated using reference numeral 105. Each element 105 forms a pixel in the image sensor 104. The pixels in the image sensor 104 are typically arranged in a two-dimensional array. For example, an image array may comprise 2272 pixels in length and 1712 pixels in height.

The image sensor 104 captures an image of a subject by converting incident light into an analog signal, and sends this representation of the image via connection 109 to an analog front end processor 111. The analog front end processor 111 typically includes an analog-to-digital converter for converting the analog signal received from the image sensor 104 into a digital signal. The analog front end processor 111 provides this digital signal as image data via connection 112 to the ASIC 102 for image processing.

The ASIC 102 is coupled to one or more motor drivers 119 via connection 118. The motor drivers 119 control the operation of various parameters of the lens 122 via connection 121. For example, lens controls, such as zoom, focus, aperture and shutter operations can be controlled by the motor drivers 119. The connection 123 between the lens 122 and the image sensor 104 is shown as a dotted line to illustrate the operation of the lens 122 focusing on a subject and communicating that information to the image sensor 104, which captures the image provided by the lens 122.

The ASIC 102 also sends display data via connection 124 to a display controller 126. The display controller may be, for example, a national television system committee (NTSC)/phase alternate line (PAL) encoder, although, depending on the application, other standards for presenting display data may be used. The display controller 126 converts the display data from the ASIC 102 into a signal that can be shown on image display 128 via connection 127. The image display 128, which can be, for example, a liquid crystal display (LCD) or other display, displays the captured image to the user of a digital camera 100, and is typically the display located on the digital camera 100. Depending on the configuration of the digital camera 100, the image shown to a user on the display 128 may be shown before the image is captured and processed (in what is referred to as a “live view” mode), and after the image is captured and processed, in what is referred to as “instant review” or “playback” mode. The instant review mode is typically used to display the captured image immediately after the image is captured. The image display 128 is also used to display various user interface information and menus, as will be described below.

The ASIC 102 couples to a microcontroller 161 via connection 154. The microcontroller 161 can be a specific or a general purpose microprocessor that controls the various operating aspects and parameters of the digital camera 100. For example, the microcontroller 161 is coupled to a user interface 164 via connection 162. The user interface 164 may include, for example but not limited to, a 4-direction set of arrow keys 142, an “OK/select” button 144, a keypad, a pointing device, a shutter release, and any other buttons or switches that allow the user of the digital camera 100 to input commands and navigate menus. In accordance with an embodiment of the invention, the expert and novice menu logic 150 cooperates with the user interface 164 to present a combination of menus to a user via the display 128. As will be described below, the expert and novice menu logic 150 develops multiple menus for presentation to a user. An “expert” menu may be provided initially, giving the sophisticated, or experienced, user the opportunity to quickly review and change settings. However, when presented with an “expert” menu, a novice user may not have sufficient experience to navigate the “expert” menu. The novice user can actuate a control on the user interface 164 to communicate to the expert and novice menu logic 150 that additional information is requested. In response to the request, the expert and novice menu logic 150 presents a detailed “novice” menu to the user via the display 128. The novice menu is nested within or otherwise sequentially linked to, the expert menu and may include additional description of a parameter, or may include suggested camera settings. In this manner, both sophisticated and novice users can use the menus provided by the user interface 164.

The ASIC 102 also couples to one or more different memory elements, to be described below with particular reference to the type of memory to which the ASIC 102 is coupled over various connections. It should be noted that while specific types of memory are denoted below, the digital camera 100 may employ various other types of memory not specifically described herein. For example, the various memory elements may comprise volatile, and/or non-volatile memory, such as, for example but not limited to, random access memory (RAM), read-only memory (ROM), and flash memory. Furthermore, the memory elements may be either internal to the digital camera 100 or may be removable memory media, and may also comprise memory distributed over various elements within the digital camera 100. All such memory types are contemplated to be within the scope of the invention.

The ASIC 102 couples to synchronous dynamic random access memory (SDRAM) 141 via connection 152. The SDRAM 141 houses the various software and firmware elements and components (not shown) that allow the digital camera 100 to perform its various functions. The ASIC 102 also couples to RAM 138 via connection 156. When the menu system is implemented in software, the software code (i.e., the expert and novice menu logic 150) is typically stored in the internal flash memory 136 or in ROM, and transferred to the RAM 138 to enable the efficient execution of the software in the ASIC 102. The internal memory can be, for example, flash memory.

The ASIC 102 also couples via connection 131 to an external memory 132, which can also be flash memory. As will be described in further detail below, the external memory 132, which can be, for example, compact flash memory, and the internal memory 136, may provide image storage 134 and 137, respectively, for captured images, as will be described below.

The ASIC 102 executes the expert and novice menu logic 150 so that multiple menus and sub-menus can be provided to a user, based on the user's skill level and based on user request.

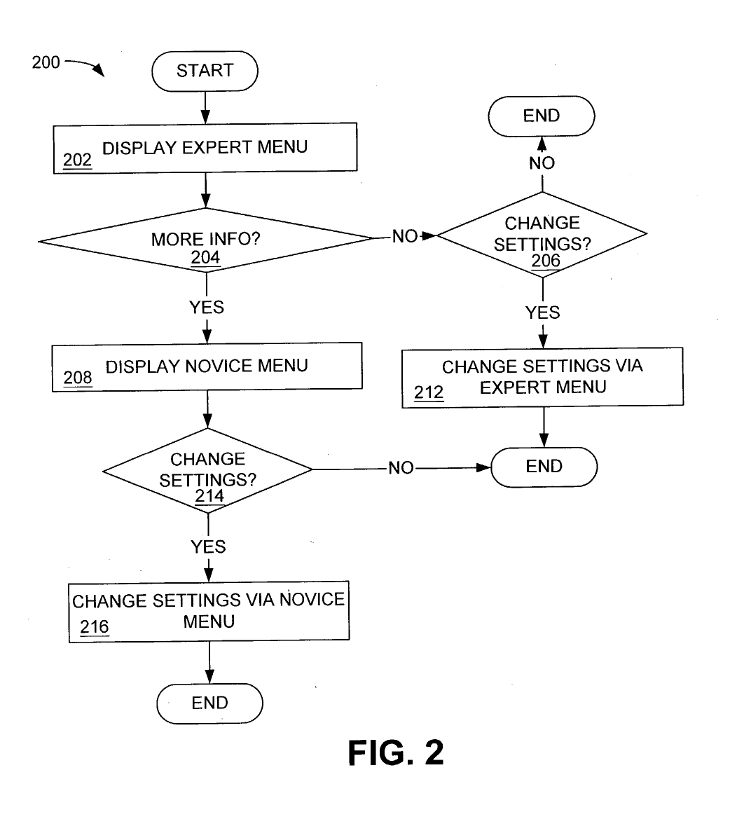

FIG. 2 is a flow chart 200 describing the operation of an embodiment of the expert and novice menu logic 150 of FIG. 1. Any process descriptions or blocks in the flow chart to follow should be understood as representing modules, segments, or portions of code, which include one or more executable instructions for implementing specific logical functions or steps in the process, and alternative implementations are included within the scope of the preferred embodiment of the present invention. For example, functions may be executed out of order from that shown or discussed, including substantially concurrently or in reverse order, depending on the functionality involved, as would be understood by those reasonably skilled in the art of the present invention.

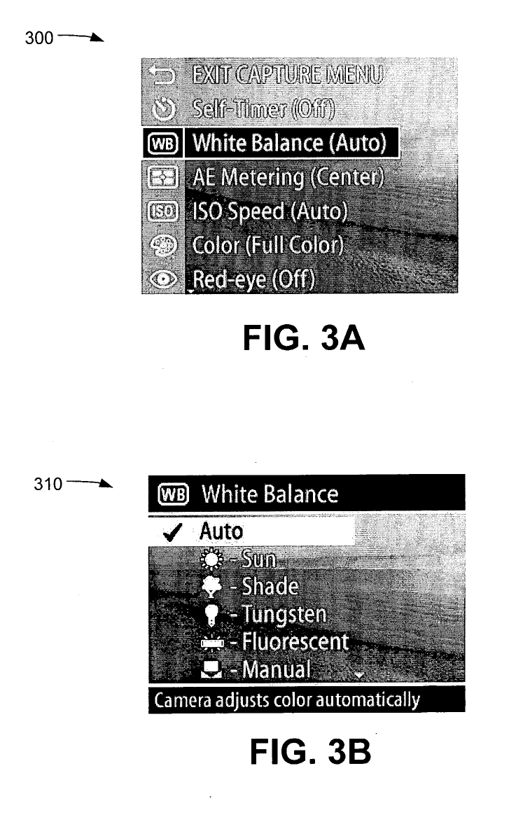

In block 202 the user initiates a menu via the user interface 164. This menu may be an “expert” menu that offers the user a simplified format from which various settings may be viewed and, if desired, changed. An example of an expert menu is shown in FIG. 3A below. The expert menu assumes that the user is familiar with the various settings and can offer a quick way to change settings. For example, a menu parameter may be offered with a current setting in parentheses. The user is assumed to know the various choices for that parameter and may use a single button on the user interface to highlight and change that parameter.

In block 204, the user determines whether additional information is desired. If the user is satisfied with the expert menu, then, in block 206, it is determined whether the user desires to make any changes. If it is determined that no changes are to be made, then the process ends. However, if it is determined in block 206 that settings are to be changed, the user uses the expert menu and the user interface 164 to make any changes to the settings in block 212 and the process ends. For example, the user may use the left/right arrows associated with the 4-direction set of arrow keys 142 to adjust the setting in the expert menu.

If, however, in block 204, the user determines that additional information is needed to understand a menu parameter, then, in block 208, the user actuates a control on the user interface so that a detailed sub-menu (i.e., a novice menu) is displayed via the display 128. For example, the user may press the OK/Select button 144, which takes them to the sub-menu. The detailed sub-menu (i.e., a novice menu) includes information corresponding to the information in the main menu, but includes additional detail. An example of a novice menu is shown in FIG. 3B below. The sub-menu may include a complete listing of choices and descriptions of possible settings, from which the user can select a desired parameter.

In block 214, it is determined whether any settings are to be changed. If no settings are to be changed, the process ends. If settings are to be changed, then, in block 216, the user changes the desired settings using the novice menu and the process ends. When the camera exits the sub-menu (novice menu), it goes back to the main menu (expert menu). Regardless of the manner in which settings are changed, the camera exits the menus the same way.

FIGS. 3A and 3B are graphical illustrations showing an example of the expert and novice menus described above. In FIG. 3A, a main menu 300 includes a listing of parameters with current settings in parentheses. If the user is familiar with the parameters and the various settings available for the parameters, the user may scroll through the choices using, for example, the left/right arrow keys on the user interface and change the various settings from the main menu 300. The main menu 300 illustrates the parameter “white balance” and has a present setting of “auto.” If the user wishes to change the “white balance” setting from this menu, they may do so by actuating, for example, the left/right arrow key on the 4-direction set of arrow keys 142.

However, if the user is unfamiliar with a setting, the user may invoke the user interface 164 by pressing, for example, the OK/Select button 144 to provide a more detailed sub-menu (novice menu) for a particular setting. In FIG. 3B, the sub-menu 310 provides a novice user a detailed explanation of the settings available for the “white balance” menu parameter. In this manner, the expert and novice menu logic 150 allows an experienced user to quickly navigate through and, if desired, change menu settings without requiring the user to navigate a sub-menu, thus minimizing the amount of time and the number of user interface operations used to view and change settings. The menu system also allows novice users to obtain a more detailed explanation of menu parameters. For example, while icons may be used for the expert menu, text may be used to explain features on the novice menu. Furthermore, additional information may be provided on the novice menu than on the expert menu. In this manner, the expert and novice menu logic 150 offers both sophisticated and novice users a simplified menu in a digital camera.

While various embodiments of the invention have been described, it will be apparent to those of ordinary skill in the art that many more embodiments and implementations are possible that are within the scope of this invention. All such modifications and variations are intended to be included herein within the scope of this disclosure and the present invention and protected by the following claims.

What is claimed is:

1. A camera comprising:
a user interface associated with the camera;
logic for providing a first menu via a display, the first menu having first information;
logic for providing a second menu via the display, the second menu nested within the first menu and having second information, wherein the second information includes details corresponding to the first information.

2. The camera of claim 1, wherein the second information includes detailed information corresponding to and excluded from the first information.

3. The camera of claim 1, wherein the first and second menus are sequentially available to a user.

4. The camera of claim 1, wherein selections in the first menu are changed using the user interface.

5. The camera of claim 4, wherein selections in the first menu are changed using a left/right arrow key.

6. The camera of claim 1, wherein the second menu is accessed from the first menu by actuating a key associated with the user interface.

7. The camera of claim 6, wherein the second menu is accessed from the first menu by actuating an OK/SELECT key associated with the user interface.

8. A method of operating a camera comprising:
displaying a first menu, the first menu having first information;
displaying a second menu, the second menu nested within the first menu and having second information, wherein the second information includes details corresponding to the first information.

9. The method of claim 8, wherein the second information includes detailed information corresponding to and excluded from the first information.

10. The method of claim 8, further comprising making the first and second menus sequentially available to a user.

11. A camera, comprising:
a multiple menu system which includes a plurality of menus, a first menu including first information, a second menu nested within the first menu and including second information, in which the second information is related to the first information, and in which the second information includes details additional to the first information.

12. The camera of claim 11, further comprising a user interface and a display, the display configured to display the first menu and to display the second menu only when requested by actuation of a control function associated with the user interface.

13. The camera of claim 11, wherein selections in the first menu are changed using the user interface.

14. The camera of claim 13, wherein selections in the first menu are changed using a left/right arrow key.

15. The camera of claim 11, wherein the second menu is accessed from the first menu by actuating a key associated with the user interface.

16. The camera of claim 15, wherein the second menu is accessed from the first menu by actuating an OK/SELECT key associated with the user interface.

17. A computer-readable medium having a program for operating a camera, the program including logic for:
displaying a first menu, the first menu having first information;
displaying a second menu, the second menu nested within the first menu and having second information, wherein the second information includes details corresponding to the first information.

18. The program of claim 17, wherein the second information includes detailed information corresponding to and excluded from the first information.

19. The program of claim 17, further comprising logic for making the first and second menus sequentially available to a user.
